(19) United States
(12) Patent Application Publication
(10) Pub. No.: US 2008/0025804 A1
(43) Pub. Date: Jan. 31, 2008

(54) Deburring cutter for a deburring tool

(76) Inventors: Ulf Heule, Balgach (CH); Heinrich Heule, Balgach (CH)

Correspondence Address: BROWDY AND NEIMARK, P.L.L.C.;624 NINTH STREET, NW, SUITE 300, WASHINGTON, DC, 20001-5303, US

(21) Appl. No.: 11/727,878

(22) Filed: Mar. 28, 2007

(30) Foreign Application Priority Data
Mar. 28, 2006 (DE) 102006014135.0

(51) Int. Cl. B23P 15/28

(52) U.S. Cl. 407/42

(57) ABSTRACT

The invention relates to a deburring cutter for a deburring tool for deburring the edges of through-bores of a workpiece, which extends radially outward and is pushed radially outward against an elastic force, the deburring cutter having an approximately wedge-shaped cutting edge, which is connected by means of a control surface to a front face. The invention is characterized in that the cutting face on the deburring cutter is disposed at a negative angle toward the surface of the workpiece.

The invention relates to a deburring cutter for a deburring tool according to the preamble of claim 1.

In a patent that originated with the same applicant, a blade known as a GHS blade was developed, which has found expression in a number of patents. This deburring cutter is characterized in that it has an approximately wedge-shaped cutting edge, which is provided with a positive angle relative to the surface of the bore edge to be deburred. This means that, with a positive inclined cutting edge, the cutting edge touches down at the bore to be deburred, along the inside, and the cutter makes contact with the bore edge, subsequently deburring the same at an oblique angle. The deburring incline corresponds to the angle that the cutting edge encloses with the bore edge.

The characterizing feature of this so-called GHS blade was that, during the action of the cutting edge, which was inclined obliquely toward the bore surface, a pulling force toward the center line of the bore was created on the blade, which, as the deburring effect progressed, caused the cutter to be displaced and to be moved radially inward toward the axis of rotation.

The force acting obliquely relative to the axis of rotation on the angled cutting edge thus resulted in a radially inward pulling force on the cutter, which was therefore pulled or pushed radially inward with a certain force component toward the axis of rotation.

Under the prior art the known cutter was held radially outward with a certain elastic force, and the obliquely inwardly directed force component acting on the cutting edge, in turn, wanted to displace the cutter radially inward against the elastic force.

In this interplay between the forces, the cutter would then perform a certain deburring action along the edge of the bore and, as soon as the radially inwardly directed force on the cutting edge became greater than the exerted opposite elastic force on the cutter, the cutter was displaced into the inside diameter of the bore, where the cutting action of the cutting edge would stop.

A cutter of this type has proven largely effective, however, with increasing wear on the cutting edge, i.e., when it becomes dull, a greater radially inward pulling force on the cutter in the direction of the axis of rotation is created sooner, with the result that the deburred surfaces along the edge of the bore became smaller. The surfaces of the deburred bore edges thus became smaller the more the cutting edge become worn, which is undesirable.

The result were variances in the size of the chamfer surfaces.

To prevent this shortcoming, the so-called DEFA cutter was developed according to additional patents by the same applicant. This cutter was characterized in that the cutting edge is oriented perpendicular to the axis of rotation of the cutter, which has the result that the cutting edge touches down flat on the surface of the bore diameter to be deburred, where it digs in. This essentially means that a cutting force was created that is directed parallel to the axis of rotation of the cutter. A radially inwardly directed pulling component was eliminated in this prior-art cutter. As a result, a steady deburring action was attained—independent of the amount of wear of the cutting edge—with relatively uniform chamfer surfaces.

Variances in the chamfer surfaces nonetheless occurred if a conical wear occurred on the cutting face, which was designed straight per se. This occurred mostly when the so-called control surface started to wear. When the control surface is worn, the chamfer surface becomes uneven and the chamfer angle was no longer reliably uniform.

The invention is therefore based on the object of improving a deburring cutter according to the subject matter of the two above-mentioned embodiments in such a way that consistently uniform chamfer surfaces are attained independent of the degree of wear of the cutting edge.

In order to meet the object at hand, the invention is characterized in that the cutting face on the deburring cutter is disposed at a negative angle toward the surface of the workpiece.

The technical teaching of the claimed subject matter creates the significant advantage that, based on the existing negative angle of the cutting face, a pulling-force component is now exerted onto the cutter that pulls the cutter radially outward away from the axis of rotation, and consequently holds the cutter very stable outwardly oriented, without there being a risk—as described in the context of the GHS blade—that the blade is displaced radially inward toward the axis of rotation as the cutting action progresses.

In accordance with the subject of the invention, an added pulling-force component on the cutter is thus created in a radially outward direction away from the axis of rotation, i.e., the cutter is pulled away from the axis of rotation and held outward in a stable manner in a stable outward position.

Such a stable outward position is maintained until the negative cutting edge transitions at a certain position into a control surface, which is disposed at a positive angle relative to the surface of the workpiece.

Due to this change from the negative cutting edge to the control surface with its positive angle, an inward pushing of the deburring cutter takes place in the radially inward direction toward the axis of rotation, and the same conditions are achieved as in the above-described DEFA blade.

The arrangement of a cutting edge with a negative angle toward the surface of the workpiece accordingly has the advantage that this cutting edge holds on to the edge of the bore like a “claw” and is pulled outward in a radially outward direction even during the cutting action and thus remains stable in this position until ultimately the negative cutting edge transitions into the positive control surface.

In this manner, perfectly straight chamfer surfaces that have a precisely defined angle are created, like they had not been known so far. Also, the size and incline of the chamfer surface is completely independent of the degree of wear on the cutting edge that is disposed at a negative angle, because even if it becomes worn, the previously described outwardly directed pulling action on the cutter always takes place, so that it remains stable in its outwardly-pulled position.

For the implementation of the subject matter of the invention, different embodiments are claimed with respect to the shape of the negative-angle cutting edge.

In a first embodiment, provision is made for the cutting edge to be designed as a straight line that is conically inclined at said negative angle.

In a second embodiment, provision may be made for this straight line to additionally be concavely arched, and in a third embodiment provision may be made for this cutting edge to be convexely arched.

Also claimed are convexely/concavely arched transitions (hence a cutting edge that is curved in an S-shape).

It is accordingly important in the case of all embodiments that, in essence, a center angle through the cutting edge is disposed at a negative angle relative to the surface of the workpiece.

This also applies for the control surface adjoining the cutting edge; it, too, may be designed as a straight line or as a crowned surface that is arched either convexely or concavely.

The invention is not limited to a single cutting edge on a deburring cutter. Provision may also be made for a deburring cutter that has two opposed cutting edges provided symmetrical relative to a center longitudinal line, so that a forward and reverse deburring action may be provided onto the edge of a through-bore.

In the most simple embodiment, however, the deburring cutter according to the invention has only one cutting edge, in order, for example, to debur the edge of a bore while being inserted into the same.

It is accordingly not essential to the invention for the two cutting edges of a deburring cutter used for through-bores, each of which is disposed at a negative angle, to also have identical angles and identical shapes.

For instance, the cutting edge that deburs the upper edge of the bore may have a different incline than, by comparison, the cutting edge that deburs the distal edge of the bore.

Likewise, provision may be made for the anterior cutting edge to be designed arcuate in any specific manner, while the cutting edge assigned to the distal edge of the bore may have a different crowned, serpentine, convex, or concave shape.

Consequently, different chamfer angles for the cutting edges may be used as well, so that, for example, a chamfer angle of 15 degrees may be used for the anterior deburring of the bore edge and a chamfer angle of 30 degrees for the distal deburring of the bore edge.

The subject matter of the present invention is based not only on the subject matter of the individual claims, but also on combinations of individual claims.

All information and features disclosed in the documentation, including in the abstract, in particular the three-dimensional design depicted in the drawing, are claimed as essential to the invention to the extent that they are novel with respect to the prior art, either individually or in combination with each other.

In the following text the invention will be explained in more detail based on drawings depicting only one of the possible embodiments. Additional characteristics and advantages of the invention will become apparent from the drawings and from their description

The drawings show as follows:

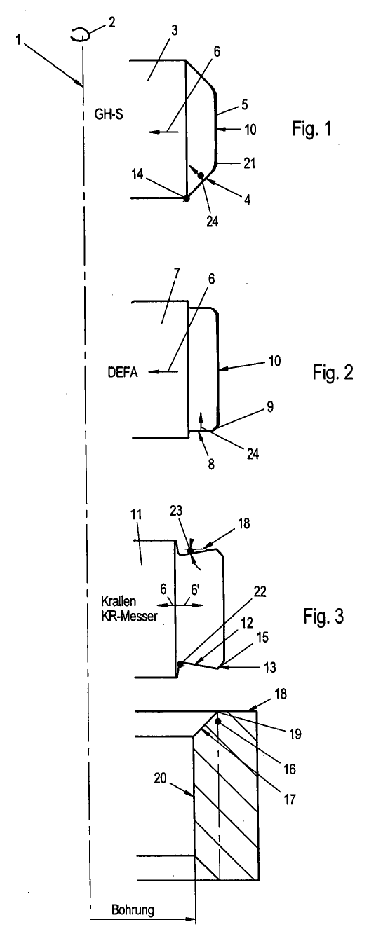

FIG. 1: a side view of a GHS deburring cutter according to the prior art,

FIG. 2: a side view of a DEFA blade according to the prior art,

FIG. 3: a side view of a deburring cutter according to the invention,

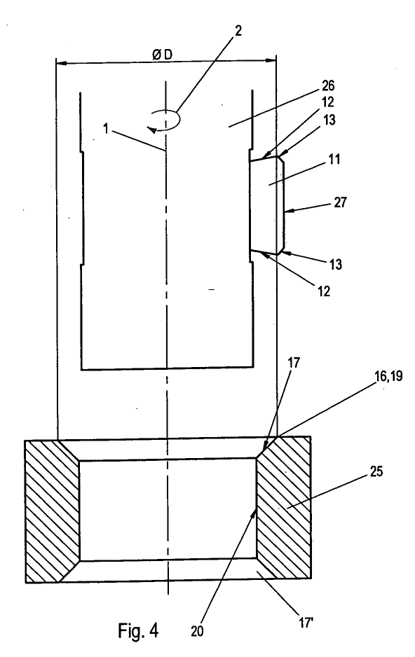

FIG. 4: a deburring cutter with its arrangement on a tool holder, after completed deburring of a through-bore,

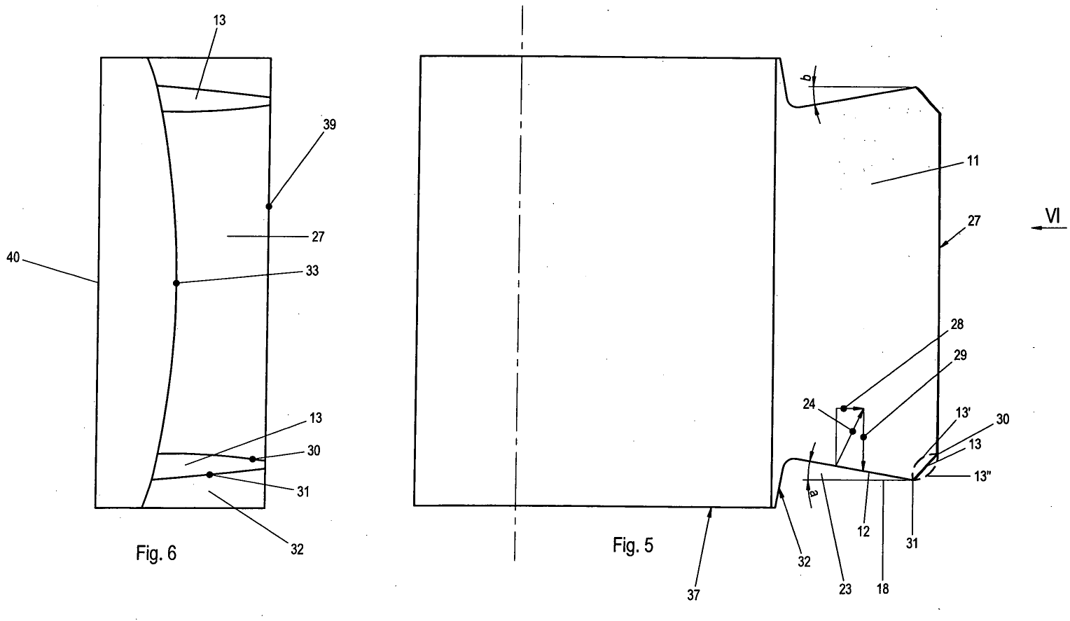

FIG. 5: a deburring cutter according to FIG. 3 in an enlarged view,

FIG. 6: a front view of the deburring cutter of FIG. 5 in the direction of the arrow VI in FIG. 5,

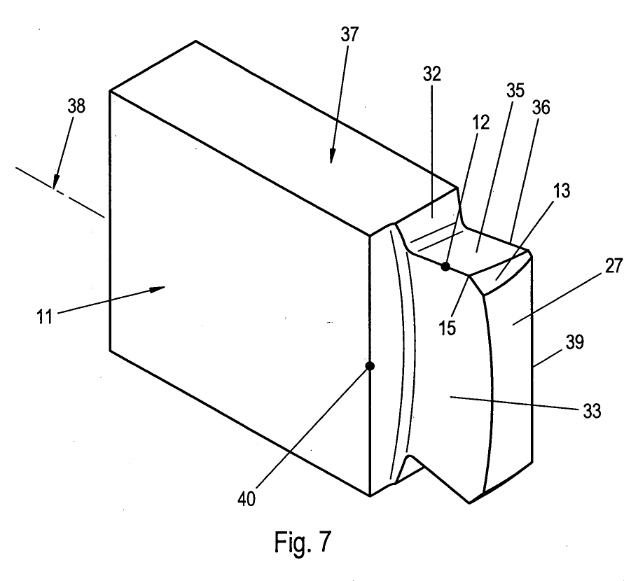

FIG. 7: a perspective rendering of the deburring cutter of FIGS. 3, 5, and 6,

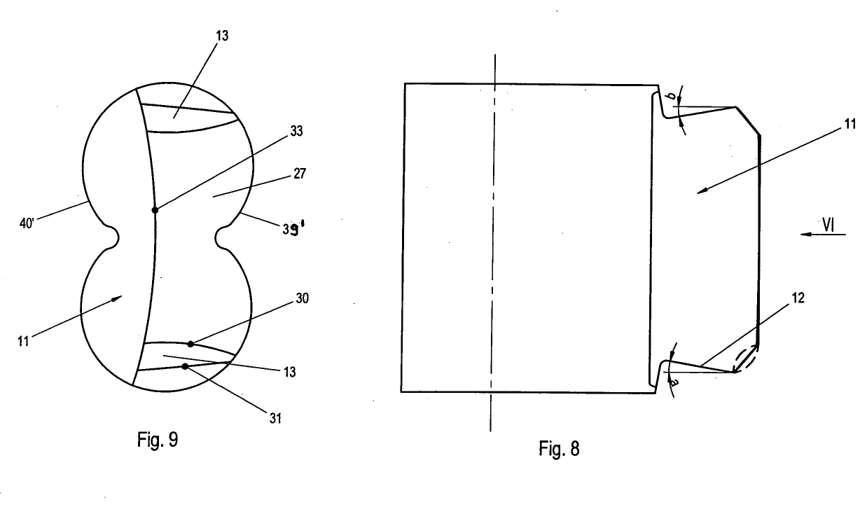

FIG. 8: a side view of an adaptation of a deburring cutter according to FIG. 5 with arcuate guide edges,

FIG. 9: the top view of the deburring cutter according to FIG. 8 in the direction of the arrow IX,

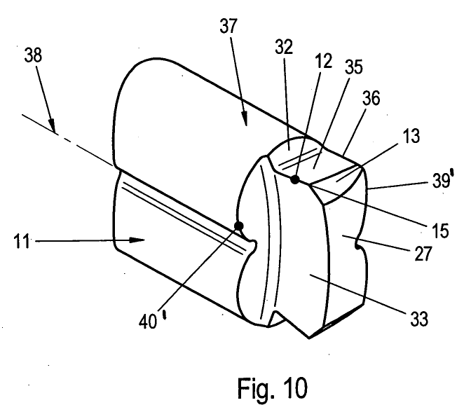

FIG. 10: a perspective view of the deburring cutter of FIGS. 7 and 8 with improved lateral and longitudinal guiding.

To begin with, deburring cutters of the prior art shall be explained with the aid of FIGS. 1 and 2.

The deburring cutters according to FIGS. 1 through 3 are driven so as to rotate, for example, in the direction of the arrow 2 or in the direction opposite thereto relative to an axis of rotation 1.

Their purpose is to be placed onto a surface of a workpiece 18 and, in the process, apply a chamfer surface 17 in the region of a bore having a bore diameter 20.

The cutter 3 (GHS cutter) is equipped for this purpose with cutting edges 4 that are disposed at a positive angle toward the workpiece surface 18. It is important in this context that when entering into the bore diameter 20, the cutting edge 4 initially sits on the workpiece surface 18 at position 14, and starting from this position 14 the cutting action takes place along the cutting edge 4. In the process, a cutting force 24 is created, which is oriented approximately normal relative to the cutting edge 4. From this follows that a pressure-force component in the direction of the arrow 6 is thereby created on the cutter 3 that wants to displace the cutter 3 inward in the direction of the arrow 6 toward the axis of rotation 1. Counteracting this direction of the arrow 6, however, is the elastic force that acts on the cutter 3 in the opposite direction, so that a relatively stable engagement of the cutting edge 4 on the workpiece surface 18 is created.

The cutting edge 4 ends at position 21 in a front face 10. The front face, in this case, is designed as a sliding radius 5. This means that as soon as position 21 enters into the bore diameter 20, the cutting action stops and the sliding radius 5 then slides along the inner surface of the bore without machining it further.

Different conditions are shown in the prior-art cutter 7 (DEFA blade) in FIG. 2. There, it is apparent that the cutting edge 8 is designed parallel to the workpiece surface 18 and, accordingly, the entire cutting edge 8 comes into engagement with the workpiece surface 18 all at once. This results in a cutting force 24 being exerted that is parallel to the axis of rotation 1, i.e., there is no inwardly pushing force on the cutter 7 acting in the direction of the arrow 6. This cutter is accordingly very stable and it is possible with this cutter to apply very stable, uniformly dimensioned chamfer surfaces 17 along the edge of a bore. In the case of this cutting edge 8, it is again a characterizing feature that it transitions into an obliquely inclined control surface 9 and that when the control surface 9 sits on the workpiece surface 18, a radially inward pulling force or pushing force on the cutter 7 is created, causing it to be displaced into the bore diameter 20.

This is where the invention comes into play, which uses a stabilized deburring action during which a resulting counterforce on the cutter 11 in the direction of the arrow 6′ is created as long as the cutting edge 12, which is disposed at a negative angle 23, is in engagement with the chamfer surface 17. It is a characterizing feature in this context that the radially situated position 15 first comes into engagement with the workpiece surface 18, and deburring actions then take place in the region of the chamfer surface 17 in the direction of the inclines (parallel to the negative cutting edge 12), and that, lastly, the cutting edge 12 moves out of engagement with the chamfer surface 17 when a control surface 13, which has a positive angle toward the workpiece surface 18, enters into the bore diameter 20.

It is therefore not essential to the invention that the cutting edge 12 machines the bore up to position 22. The position 22 on the cutting edge does not need to be in engagement with the bore diameter.

What is important is that a radially outward pulling force in the direction of the arrow 6 counter to the above-mentioned radially inward force is created on the cutter 11, holding the same stable in the position shown in FIG. 3 during the entire cutting process, and a change takes place only when a control surface 13, which has a positive angle relative to the workpiece surface 18, comes into engagement with the workpiece surface 18.

This means that machining first begins at the outer chamfer diameter 16 in position 19, and the remaining deburring action is then performed in a radially inward direction along the chamfer surface 17. This is an exact opposite movement as compared to the deburring cutter 3 of FIG. 1.

FIG. 4 shows the complete deburring of a through-bore in a workpiece 25, where the deburring cutter 11 has already applied the respective chamfer surfaces 17 at the front and 17′ at the rear.

It is still apparent here that the deburring cutter is disposed on a tool holder 26, which is driven so as to rotate in the above-mentioned axis of rotation 1, for example in the direction of the arrow 2.

Additional details are apparent from FIGS. 4 and 5.

First, it is apparent by comparing FIGS. 5 and 6, that the front face 27 of the deburring cutter 11 has an approximately rectangular cross section. This means that the right and left side edges 39, 40 are oriented approximately parallel to each other, thereby forming the approximately rectangular front face 27 of the deburring cutter.

Also shown in FIG. 5 is the splitting of the cutting force 24 into the two vertical components. It is apparent that a pulling force 28 on the cutter is exerted radially outward from the axis of rotation 1 on the deburring cutter, while the normal force 29 performs the cutting action.

This normal force 29 is oriented perpendicular to the workpiece surface 18.

Numeral 23 accordingly depicts the negative angle of the cutting edge 12 toward the workpiece surface 18. Also depicted is that the control surface 13 may be designed either as a straight line or as a concave surface (control surface 13′), or as a convex surface.

The control surface 13 starts at position 31 and ends at a certain distance in the front face 27.

From FIG. 6, the boundaries with the edges 30, 31 of the control surface 13 are shown in more detail.

Also shown in FIG. 6 is a chip removal surface 33, and it is apparent that the cutting edge 12 ends radially inward in a non-contacting area 32, which is accommodated there for manufacturing reasons and does not perform any cutting action.

FIG. 7 shows the perspective view of a cutter according to FIGS. 5 and 6.

It is apparent here that the chip removal surface 33 is arched as an arcuate curve (chip deflector curve) to remove the chips that are generated at the cutting edge 12. This chip removal surface 33 is bounded by a lateral edge 40, of which the above-mentioned parallel edge 39 is a part.

It is important that the cutting edge 12 is higher than the free edge 36, to permit a shaving effect of the cutting edge, since the free edge 36 must always be kept out of engagement with the workpiece. This is why the free surface 35 is provided, which ensures that always only the cutting edge 12 is in cutting engagement with the workpiece surface 18.

In the blade surface 37, the entire cutter is guided longitudinally in the tool holder 26 in such a way that the longitudinal guidance is additionally also effected by the surfaces that are defined by the edges 39 and 40. This means that an approximately rectangular penetration takes place in the tool holder 26 in which this cutter 11 is displaceably guided.

FIGS. 8 and 9, in contrast, show an approximately spectacle-shaped cutter, in which the edges 39 and 40 are no longer parallel but have been replaced by arcuate edges 39′ and 40′. This then no longer results in a rectangular recess in the tool holder, but in an approximately spectacle-shaped (double C-shaped) recess in the tool holder to permit an improved angled guidance of the cutter 11.

FIG. 10 shows the perspective view of a double C-shaped deburring cutter depicted in FIGS. 8 and 9 with the improved lateral and longitudinal guidance in a tool holder 26.

### DRAWING LEGEND

1 axis of rotation
2 direction of arrow
3 cutter (prior art)
4 cutting edge
5 sliding radius
6 direction of arrow 6′
7 cutter (prior art)
8 cutting edge
9 control surface
10 front face
11 cutter (invention)
12 cutting edge
13 control surface 13′, 13″
14 position
15 position
16 outside chamfer diameter
17 chamfer surface 17′
18 workpiece surface
19 position
20 bore diameter
21 position
22 position
23 negative angle
24 cutting force
25 workpiece
26 tool holder
27 front face
28 pulling force
29 normal force
30 edge
31 edge
32 non-contacting area
33 chip removal surface
34 not used
35 free surface
36 free edge
37 blade
38 center line
39 edge 39′
40 edge 40′

What is claimed is:

1. A deburring cutter for a deburring tool for deburring the edges of through-bores of a workpiece (25), which extends radially outward and is pushed radially outward against an elastic force, the deburring cutter having at least one approximately wedge-shaped cutting edge (12), which is connected by means of a control surface (13, 13′, 13″) to a front face (27), characterized in that the cutting face on the deburring cutter is disposed at a negative angle (23) toward the workpiece surface (18).

2. A deburring cutter according to claim 1, characterized in that the negative angle (23) of the cutting face creates a pulling force component on the cutter, which pulls the cutter (11) radially outward in the direction away from the axis of rotation (1) and holds the cutter (11) outwardly directed relatively stable in a stable outward position.

3. A deburring cutter according to claim 1 or 2, characterized in that the negative cutting edge (12) transitions, at a certain position of the deburring cutter in the workpiece (25), into a control surface (13, 13′), which creates an inward pushing action of the deburring cutter in the radially inward direction toward the axis of rotation (1).

4. A deburring cutter according to any of the above claims 1 through 3, characterized in that the cutting edge (12) with its negative angle (23) creates straight chamfer surfaces (17, 17′) that are provided with a precisely defined angle, the size and incline of the chamfer surfaces (17, 17′) being substantially independent of the degree of wear of the cutting edge (12).

5. A deburring cutter according to any of the above claims 1 through 4, characterized in that the cutting edge (12) is designed as straight line that is conically inclined at a negative angle (23).

6. A deburring cutter according to any of the above claims 1 through 5, characterized in that the inclined straight surface is additionally designed arched concavely, convexely, or s-shaped, a center angle through the cutting edge (8) being disposed at a negative angle (23) relative to the workpiece surface (18).

7. A deburring cutter according to any of the above claims 1 through 6, characterized in that the control surface (13) adjoining the cutting edge (12) is designed as a straight line or as a crowned surface, the crowned surface being designed concave or arched.

8. A deburring cutter according to any of the above claims 1 through 7, characterized in that two opposite cutting edges (12) that are symmetrically opposed relative to a longitudinal center line each have different angles and shapes.

9. A deburring cutter according to any of the above claims 1 through 8, characterized in that a radially outwardly located position (15) first is in engagement with the workpiece surface (18), and that deburring actions are then performed in the direction of the inclines parallel to the negative cutting edge (12) in the region of the chamfer surface (17), and that the cutting edge (12) is out of engagement with the chamfer surface (17) when the control surface (13), which has a positive angle toward the workpiece surface (18), enters into the bore diameter (20).

10. A deburring cutter according to any of the above claims 1 through 9, characterized in that, counter to a radially inward force, a radially outward pulling force in the direction of the arrow (6′) is created on the cutter (11), keeping it stable in position during the entire cutting action, and a change takes place only when a control surface 13, which has a positive angle relative to the workpiece surface 18, comes into engagement with the workpiece surface 18.

11. A deburring cutter according to any of the above claims 1 through 10, characterized in that the deburring cutter is disposed on a tool holder (26), which is driven in the axis of rotation (1), so as to rotate, for example in the direction of the arrow (2).

12. A deburring cutter according to any of the above claims 1 through 11, characterized in that the front face (27) of the deburring cutter 11 has an approximately rectangular cross section, the right and left side edges (39, 40) being oriented approximately parallel to each other and forming the approximately rectangular front face (27) of the deburring cutter.

13. A deburring cutter according to any of the above claims 1 through 12, characterized in that the cutting force created on the cutting edge (12) is made up of a pulling force (28) that is exerted on the deburring cutter radially outward away from the axis of rotation (1), and a normal force (29), the normal force (29) being oriented perpendicular to the workpiece surface (18) and performing the cutting action.

14. A deburring cutter according to any of the above claims 1 through 13, characterized in that adjoining the radially inwardly oriented cutting edge (12) is a chip removal surface (33) for removal of the chips, which is bounded by a lateral edge (40), the cutting edge (12) being disposed higher than the free edge (36) so as to achieve a shaving effect, the free edge being connected to the cutting edge (12) via a free surface (35).

15. A deburring cutter according to any of the above claims 1 through 14, characterized in that the cutter (11) is designed rectangular with parallel edges (39, 40) or eyeglass-shaped (double C-shaped) with arcuate edges (39′, 40′), the corresponding recess for receiving the deburring cutter in the tool holder being designed identical, the double C-shape having an improved edge guidance for the cutter (11).
